(19) United States
(12) Patent Application Publication
(10) Pub. No.: US 2010/0317335 A1
(43) Pub. Date: Dec. 16, 2010

(54) Systems and Methods for Remotely Configuring a Mobile Device

(75) Inventors: Andrew Borovsky, New York, NY (US); Gerard Thomas Knight, New York, NY (US); Andrew Lin, San Francisco, CA (US)

Correspondence Address: BAKER BOTTS L.L.P., 2001 ROSS AVENUE, SUITE 600, DALLAS, TX, 75201-2980, US

(73) Assignee: 80/20 Group, LLC, New York, NY (US)

(21) Appl. No.: 12/483,149

(22) Filed: Jun. 11, 2009

(51) Int. Cl. H04M 3/00

(52) U.S. Cl. 455/419

(57) ABSTRACT

In particular embodiments, a system is described that includes one or more management servers comprising instructions operable when executed to present a user interface displayable at a remote host computer, the user interface enabling a user at the remote host computer to input management information for managing a mobile device; receive the management information input by the user; update configuration information in a configuration database for the mobile device based on the management information; and send the configuration information to the mobile device for configuring the mobile device. In particular embodiments, the instructions are further operable when executed to access one or more third party servers; pull third party information from the third party servers; aggregate and reconcile the pulled third party information with the configuration information stored in the configuration information database; and store the reconciled configuration information in the configuration information database.

### TECHNICAL FIELD

The present disclosure relates generally to systems and methods for remotely configuring a mobile device.

### BACKGROUND

Basic cellular phones and feature phones still outsell traditional smartphones by an order of magnitude. By way of example, current estimates put the market share of smartphones at less than 20%. Basic cellular and feature phones generally have less sophisticated operating systems, displays, user interfaces, menus, and functionality. Additionally, while the number of users utilizing social networking services such as Twitter, Myspace, and Facebook and other online services is increasing rapidly, many users of these and other services are unable to purchase smartphones do to financial or other reasons, or are unwilling to do so because of the inherent complexity of traditional smartphones.

### BRIEF DESCRIPTION OF THE DRAWINGS

FIG. 1 illustrates an example computer network environment.

FIG. 2 illustrates a schematic representation of the main components of an example computer system.

FIG. 3 illustrates a schematic representation of the main components of an example mobile device.

FIG. 4 illustrates a diagrammatic front view of an example mobile device.

FIG. 5 illustrates an example interface for entering contact management information.

FIG. 6 illustrates an example interface for viewing and/or editing contact information.

FIG. 7 illustrates an example interface for viewing and/or editing messages.

FIG. 8 illustrates an example interface for entering multimedia management information.

FIG. 9 illustrates an example interface for viewing and/or editing multimedia information.

### DESCRIPTION OF EXAMPLE EMBODIMENTS

The present disclosure is now described in detail with reference to a few preferred embodiments thereof as illustrated in the accompanying drawings. In the following description, numerous specific details are set forth in order to provide a thorough understanding of the present disclosure. It is apparent, however, to one skilled in the art, that the present disclosure may be practiced without some or all of these specific details. In other instances, well known process steps and/or structures have not been described in detail in order to not unnecessarily obscure the present disclosure. In addition, while the disclosure is described in conjunction with the particular embodiments, it should be understood that this description is not intended to limit the disclosure to the described embodiments. To the contrary, the description is intended to cover alternatives, modifications, and equivalents as may be included within the spirit and scope of the disclosure as defined by the appended claims.

The present disclosure relates generally to systems and methods for remotely configuring a mobile device such as, by way of example and not by way of limitation, a mobile phone. In particular embodiments, a user at a remote computer is presented with a user interface for managing configuration information for the user's mobile device. In particular embodiments, the mobile device is a mobile phone having a simple and elegant user interface and, in particular example embodiments, a relatively limited display and means for providing input relative to a typical remote computer such as, by way of example, a laptop computer or general desktop computer. In particular embodiments, the user enters management information via the user interface presented at the remote computer and, subsequently, a management system updates configuration information at a database based on the management information. In particular embodiments, the management system subsequently transmits the updated configuration information to the mobile device. In such a manner, the user is able to manage the mobile device with a relatively larger display and with relatively more easy, efficient, powerful and conducive input means (e.g., a mouse and keyboard, etc.) than the limited display and input means of the mobile device itself. Moreover, the mobile device may be managed without requiring the mobile device to be physically connected to or physically coupled with either the management system or the remote computer.

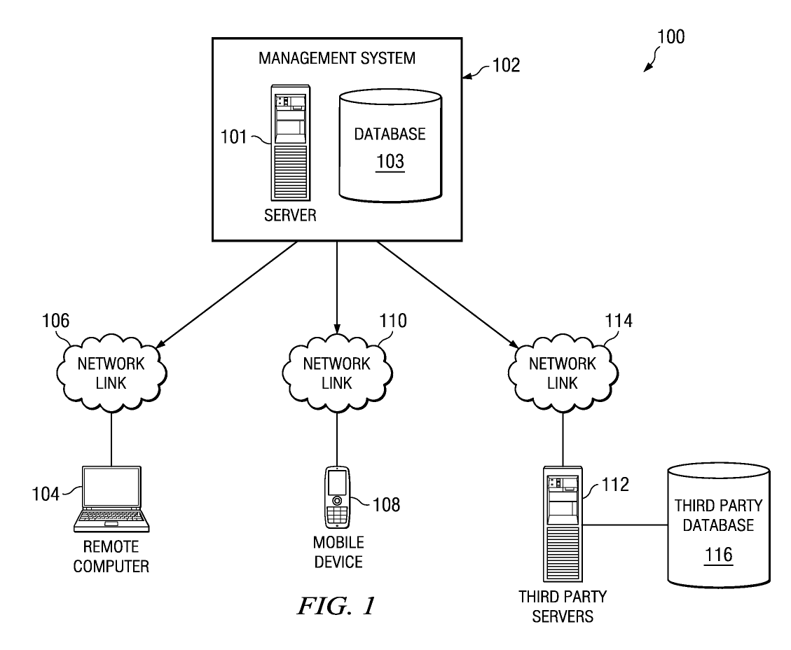

FIG. 1 illustrates a block diagram of a computer network environment 100 in accordance with an example embodiment. Computer network environment 100 includes a management system 102, a remote computer system 104, a network link 106 by which management system 102 and remote computer system 104 are able to communicate, a mobile device 108, and a network link 110 by which management system 102 and mobile device 108 are able to communicate. In various embodiments, management system 102 may actually comprise one or more management servers 101 and one or more configuration information databases 103 that may each include tangible computer-readable storage media that may store configuration and management information received by or useable by management servers 101 and, more generally, management system 102. Generally, remote computer system 104 may be any suitable computer system (e.g., desktop computer, laptop computer, etc.) capable of establishing a network computing session with management system 102 via network link 106. In particular embodiments, computer network environment 100 also includes one or more third party servers 112 and a network link 114 by which management system 102 and third party servers 112 are able to communicate. Additionally, third party servers 112 may be in communication with one or more third party databases 116 that may each include tangible computer-readable storage media that may store information collected by or useable by third party servers 112.

While only a single mobile device 108 is shown in FIG. 1, it should be appreciated that management system 102 may be simultaneously in communication with a plurality of mobile devices 108 and a plurality of remote computers 104 via corresponding network links. By way of example, management system 102 may serve and be in simultaneous communication with hundreds, thousands, or even millions of mobile devices 108 and remote computers 104.

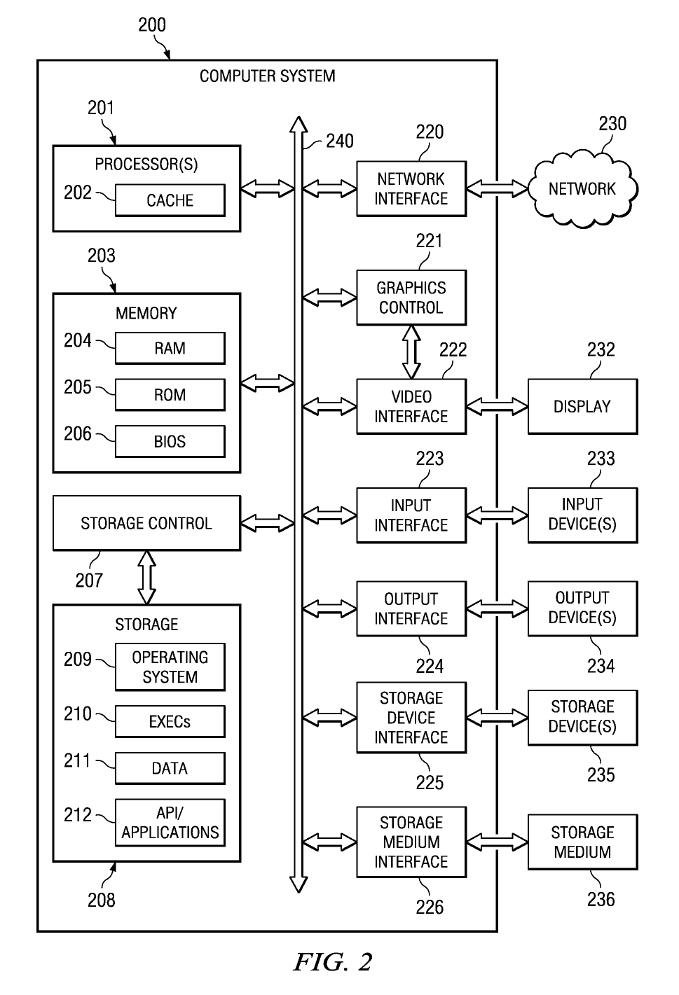

Management system 102 may actually include one or more software components residing at one or more computer systems or servers 101. Software components of management system 102 may be at one or more of the same computer systems 101. FIG. 2 illustrates an example computer system 200. Management system 102 may include software components at one or more computer systems, which may be similar to example computer system 200. Particular embodiments may implement various functions of management system 102 as hardware, software, or a combination of hardware and software. As an example and not by way of limitation, one or more computer systems may execute particular logic or software to perform one or more steps of one or more processes described or illustrated with respect to management system 102. One or more of the computer systems may be unitary or distributed, spanning multiple computer systems or multiple datacenters, where appropriate. The present disclosure contemplates any suitable computer system. Herein, reference to logic may encompass software, and vice versa, where appropriate. Reference to software may encompass one or more computer programs, and vice versa, where appropriate. Reference to software may encompass data, instructions, or both, and vice versa, where appropriate. Similarly, reference to data may encompass instructions, and vice versa, where appropriate.

One or more tangible computer-readable media may store or otherwise embody software implementing particular embodiments. A tangible computer-readable medium may be any medium capable of carrying, communicating, containing, holding, maintaining, propagating, retaining, storing, transmitting, transporting, or otherwise embodying software, where appropriate. A tangible computer-readable medium may be a biological, chemical, electronic, electromagnetic, infrared, magnetic, optical, quantum, or other suitable medium or a combination of two or more such media, where appropriate. A tangible computer-readable medium may include one or more nanometer-scale components or otherwise embody nanometer-scale design or fabrication. Example tangible computer-readable media include, but are not limited to, application-specific integrated circuits (ASICs), compact discs (CDs), field-programmable gate arrays (FPGAs), floppy disks, floptical disks, hard disks, holographic storage devices, magnetic tape, caches, programmable logic devices (PLDs), random-access memory (RAM) devices, read-only memory (ROM) devices, semiconductor memory devices, and other suitable computer-readable media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose computer system may execute software implementing particular embodiments, where appropriate.

The components in FIG. 2 are examples only and do not limit the scope of use or functionality of any hardware, software, embedded logic component, or a combination of two or more such components implementing particular embodiments. Computer system 200 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers. Computer system 200 includes a display 232, one or more input devices 233 (which may, for example, include a keypad, a keyboard, a mouse, a stylus, etc.), one or more output devices 234 (which may, for example, include one or more speakers), one or more storage devices 235, and various tangible storage media 236.

Bus 240 connects a wide variety of subsystems. Herein, reference to a bus encompasses one or more digital signal lines serving a common function, where appropriate. Bus 240 may be any of several types of bus structures including a memory bus, a peripheral bus, or a local bus using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, and an Accelerated Graphics Port (AGP) bus.

Processor(s) 201 (or central processing unit(s) (CPU(s))) optionally contains a cache memory unit 202 for temporary local storage of instructions, data, or computer addresses. Processor(s) 201 are coupled to storage devices including memory 203. Memory 203 may include random access memory (RAM) 204 and read-only memory (ROM) 205. ROM 205 may act to communicate data and instructions unidirectionally to processor(s) 201, and RAM 704 may act to communicate data and instructions bidirectionally with processor(s) 201. ROM 205 and RAM 204 may include any suitable computer-readable media described below. Fixed storage 208 is connected bidirectionally to processor(s) 201, optionally through storage control unit 207. Fixed storage 208 provides additional data storage capacity and may also include any suitable computer-readable media described. Storage 208 may be used to store operating system 209, EXECs 210, data 211, application programs 212, and the like. Typically, storage 208 is a secondary storage medium (such as a hard disk) that is slower than primary storage. Information in storage 208 may, in appropriate cases, be incorporated as virtual memory in memory 203.

Processor(s) 201 is connected to multiple interfaces, such as graphics control 221, video interface 222, input interface 223, output interface 224, and storage interface 225. These interfaces are in turn connected to appropriate devices, as illustrated. In general, an input/output (I/O) device may be a video display, a track ball, a mouse, a keyboard, a microphone, a touch-sensitive display, a transducer card reader, a magnetic- or paper- tape reader, a tablet, a stylus, a voice or handwriting recognizer, a biometrics reader, another computer systems, or other suitable I/O device or a combination of two or more such I/O devices. Processor(s) 201 may connect to another computer system or to telecommunications network 230 (which may include network links 106 and 110) through network interface 220. With network interface 220, CPU 201 may communicate with network 230 in the course of performing one or more steps of one or more processes described or illustrated herein, according to particular needs. Moreover, one or more steps of one or more processes described or illustrated herein may execute solely at CPU 201. In addition or as an alternative, one or more steps of one or more processes described or illustrated herein may execute at multiple CPUs 201 that are remote from each other across network 230.

In particular embodiments, when computer system 200 is connected to network 230, computer system 200 may communicate with other devices, specifically remote computer system 104 and mobile device 108, connected to network 230. Communications to and from computer system 200 may be sent through network interface 220. For example, network interface 220 may receive incoming communications (such as requests or responses from other devices) in the form of one or more packets (such as Internet Protocol (IP) packets) from network 230 and computer system 200 may store the incoming communications in memory 203 for processing. Computer system 200 may similarly store outgoing communications (such as requests or responses to other devices) in the form of one or more packets in memory 203 and communicated to network 230 from network interface 220. Processor(s) 201 may access these communication packets stored in memory 203 for processing.

Computer system 200 may provide functionality as a result of processor(s) 201 executing software embodied in one or more computer-readable storage media, such as memory 203. Memory 203 may store software that implements particular embodiments, and processor(s) 201 may execute the software. Memory 203 may read the software from one or more other computer-readable media (such as mass storage device(s) 235) or from one or more other sources through a suitable interface, such as network interface 220. The software may cause processor(s) 201 to carry out one or more processes or one or more steps of one or more processes described or illustrated herein. Carrying out such processes or steps may include defining data structures stored in memory 203 and modifying the data structures as directed by the software. In addition or as an alternative, computer system 200 may provide functionality as a result of logic hardwired or otherwise embodied in a circuit, which may operate in place of or together with software to execute one or more processes or one or more steps of one or more processes described or illustrated herein. Herein, reference to software may encompass logic, and vice versa, where appropriate. Moreover, reference to a computer-readable medium may encompass a circuit (such as an IC) storing software for execution, a circuit embodying logic for execution, or both, where appropriate. The present disclosure encompasses any suitable combination of hardware, software, or both.

Similarly, remote computer system 104 may include any or all of the functionality of example computer system 200.

Network links 106, 110, and 114 may constitute any link or links by which management system 102 is able to communicate with remote computer system 104, mobile device 108, and third party servers 112, respectively. By way of example, network links 106, 110, and 114 may include any number or arrangement of interconnected links or networks including both wired and wireless, particularly Wi-Fi certified, networks. Network link 110, in particular, may generally include a GSM (Global System for Mobile communications) mobile phone network, UMTS (Universal Mobile Telecommunications System) network (e.g., 3G network), an EDGE compatible (Enhanced Data rates for GSM Evolution) network, or any other mobile telephone network. In various embodiments, any type of wireless or other communications link 110 may be utilized. For example, a wireless communication network link over which mobile device 108 communicates may utilize a cellular-based communication infrastructure that includes cellular-based communication protocols such as AMPS, CDMA, TDMA, GSM, iDEN, GPRS, EDGE, UMTS, WCDMA and their variants, among others.

In particular embodiments, each mobile device 108 may include some of the functionality described with reference to example computer system 200. In particular embodiments, mobile device 108 is a mobile phone such as a basic or feature cellular phone. By way of example, mobile device 108 may be a basic or feature mobile phone manufactured by Nokia, Samsung, Sony Ericsson, Motorola, or LG Electronics, among other suitable manufacturers. Additionally, in particular embodiments, mobile device 108 has a small form factor and basic (e.g., not incorporating touchscreen technology) limited sized display. However, in alternate embodiments, mobile device 108 may be a smartphone (e.g., the iPhone or iPhone 3G manufactured by Apple Inc. of Cupertino, Calif., the BlackBerry manufactured by Research in Motion (RIM), the G1 manufactured by Google, or Omnia manufactured by Samsung Electronics Corporation), personal digital assistant, or other multimedia device including, by way of example and not by way of limitation, digital photo frames, auto (as well as non-auto) navigation systems, and other net devices. Additionally, mobile device 108 may be affiliated and supported by any suitable carrier or network service provider such as, by way of example, Sprint PCS, T-Mobile, Verizon, AT&T, or other suitable carrier.

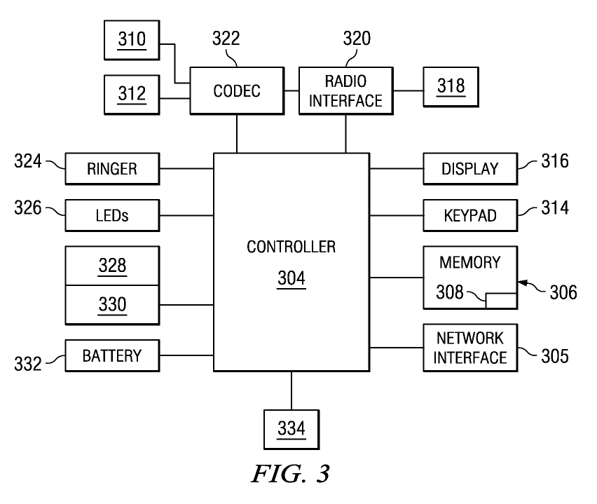

FIG. 3 shows a schematic representation of the main components of an example mobile phone 108, according to various particular embodiments, which is adapted for use in connection with a GSM network or any other mobile telephone network as described above, and which may also be configured to meet the wireless application protocol specification (WAP). Mobile device 108 generally includes a controller 304 which may comprise a microcontroller or one or more processors configured to execute instructions and to carry out operations associated with mobile device 108. In various embodiments, controller 304 may be implemented as a single-chip, multiple chips and/or other electrical components including one or more integrated circuits and printed circuit boards. Controller 304 may optionally contain a cache memory unit for temporary local storage of instructions, data, or computer addresses. By way of example, using instructions retrieved from memory, controller 304 may control the reception and manipulation of input and output data between components of mobile device 108.

Controller 304 together with a suitable operating system may operate to execute instructions in the form of computer code and produce and use data. By way of example and not by way of limitation, the operating system may be Windows-based, Mac-based, or Unix or Linux-based, or Symbian-based, among other suitable operating systems. In a particular embodiment, the operating system is built on the Android operating platform developed by Google and the Open Handset Alliance. The operating system, other computer code (including configuration client 308 described below) and/or data may be physically stored within a memory block 306 that is operatively coupled to controller 304.

Memory block 306 encompasses one or more storage mediums and generally provides a place to store computer code (e.g., software and/or firmware) and data that are used by mobile device 108. By way of example, memory block 306 may include various tangible computer-readable storage media including Read-Only Memory (ROM) and/or Random-Access Memory (RAM). As is well known in the art, ROM acts to transfer data and instructions uni-directionally to controller 304, and RAM is used typically to transfer data and instructions in a bidirectional manner. Memory block 306 may also include one or more fixed storage devices in the form of, by way of example, magnetic or solid-state hard disk drives (HDDs), among other suitable forms of memory coupled bi-directionally to controller 304. Information may also reside on a removable storage medium loaded into or installed in mobile device 108 when needed. By way of example, any of a number of suitable memory cards may be loaded into mobile device 108 on a temporary or permanent basis. By way of example, mobile device 108 may also include a subscriber identification module (SIM) card 328 and a SIM card reader 330.

Controller 304 is also generally coupled to a variety of interfaces such as graphics control, video interface, input interface, output interface, and storage interface, and these interfaces in turn are coupled to the appropriate devices. Controller 304 is also coupled to a network interface 305 that allows mobile device 108, and particularly controller 304, to be coupled to another computer (e.g., management system 102) or telecommunications network (e.g., network link 110). More particularly, network interface 305 generally allows controller 304 to receive information from network link 110, or might output information to the network link in the course of performing various method steps described below. Communications may be sent to and from mobile device 108 via network interface 305. By way of example, incoming communications, such as a request or a response from another device (e.g., management system 102), in the form of one or more packets, may be received from network link 110 at network interface 305 and stored in selected sections in memory block 306 for processing. Outgoing communications, such as a request or a response to another device (e.g., management system 102), again in the form of one or more packets, may also be stored in selected sections in memory 306 and sent out to network link 110 at network interface 305. Controller 304 may access these communication packets stored in memory 306 for processing.

Electric signals (e.g., analog) may be produced by microphone 310 and fed to earpiece 312. Controller 304 may receive instruction signals from keypad 314 (which may include soft keys) and control the operation of display 316 (In alternate embodiments, keypad 314 may be implemented as a virtual keypad displayed on display 316). In particular example embodiments, display 316 is a basis display that does not incorporate touchscreen technology (although in some alternate embodiments display 316 may incorporate touchscreen technology). By way of example, display 316 may incorporate liquid crystal display (LCD), light emitting diode (LED), Interferometric modulator display (IMOD), or any other suitable display technology. Radio signals may be transmitted and received by means of an antenna 318 that may be connected through a radio interface 320 to codec 322 configured to process signals under control of controller 304. Thus, in use for speech, codec 322 may receive signals (e.g., analog) from microphone 310, digitize them into a form suitable for transmission, and feed them to radio interface 320 for transmission through antenna 318 to, for example, a public land mobile network (PLMN). Similarly, received signals may be fed to codec 322 so as to produce signals (e.g., analog) which may be fed to ear piece 312. Mobile device 108 also generally includes a ringer (e.g., speaker) 324 and may also include light emitting diodes (LEDs) 326. In some embodiments, mobile device 108 may be a dual mode phone having a wireless local area network (WLAN) interface, Worldwide Interoperability for Microwave Access (WiMAX) interface, and/or other wireless or physical interfaces (such as BlueTooth® and USB). Additionally, mobile device 108 may be powered by a removable battery pack 332.

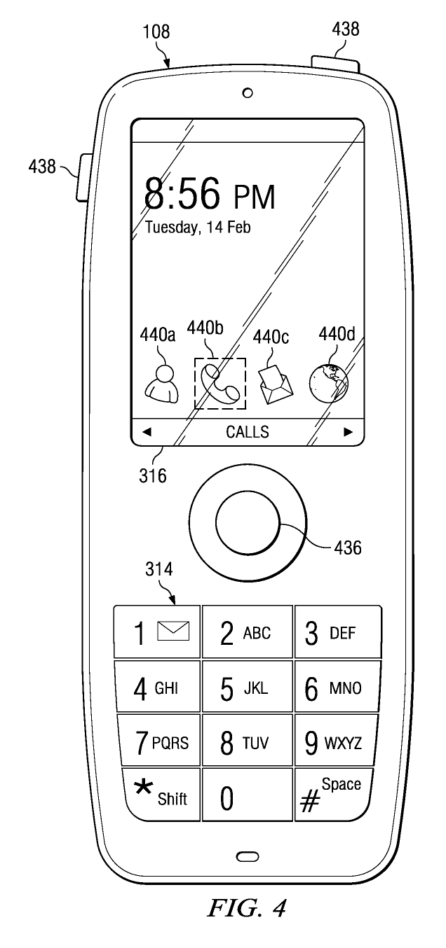

Mobile device 108 may also include one or more user input devices 334 (other than keypad 314) that are operatively coupled to the controller 304. Generally, input devices 334 are configured to transfer data, commands and responses from the outside world into mobile device 108. By way of example, in particular embodiments, mobile device includes a joystick or directional pad 436 as shown in FIG. 4, which illustrates a physical implementation of an example mobile device 108. Input devices 334 may also include one or more hard buttons 438. In even more particular embodiments, mobile device 108 includes a basic numeric keypad 314 having only approximately 10 to 12 keys (e.g., one key per numeric digit and optionally two more keys), only one or two hard buttons 438 (e.g., “back” and “ok”), and a basic joystick or directional pad 436 enabling “up,” “down,” “left,” and “right” movement. In some embodiments, joystick 436 may also enable or register diagonal movement (e.g., “up/right”). In still other embodiments, pushing the joystick 436 into or towards the mobile device 108 may initiate functionality.

As is also shown in FIG. 4, display device 316 is generally configured to display a graphical user interface (GUI) that provides an easy to use visual interface between a user of the mobile device 108 and the operating system or application(s) running on the mobile device. Generally, the GUI presents programs, files and operational options with graphical images. During operation, the user may select and activate various graphical images displayed on the display 316 in order to initiate functions and tasks associated therewith. In particular embodiments, controller 304 and display 316 are configured to display one or more icons or menu headings 440 (hereinafter referred to as icons 440). By way of example, in one particular embodiment, icons 440 include four and only four icons: a contacts icon 440a, a calls icon 440b, a messages icon 440c, and a widgets or applications icon 440d (hereinafter referred to as widgets icon).

By way of example, contacts icon 440a may, when selected with, by way of example, joystick 436, show one or more contacts of the user in the form of, by way of example, a contacts list. The contacts list may include, for example, phone numbers of the contacts, names of the contacts, display names of the contacts (e.g., display names for social networking sites or handles for instant messaging accounts), email addresses of the contacts, residential addresses of the contacts, personal webpages of the contacts, social networking webpages of the contacts, statuses of the contacts, photos of the contacts, among other contact information. Calls icon 440b may, by way of example, when selected with, by way of example, joystick 436, show a recent call history list, a favorites list, a voicemail list, among other call information. Messages icon 440c may, by way of example, when selected with, by way of example, joystick 436, show a list of sent, received or saved text messages. Messages icon 440c may also be configured to show a list of email messages, social networking messages, instant messaging (IM) messages, multimedia messages (e.g., MMS messages), among other messaging information. By way of example, all of the aforementioned messages may be aggregated into a single messages list. Alternately, the user may specify that only messages from selected sources (e.g., text and IM) are displayed. Widgets icon 440d may, by way of example, when selected with, by way of example, joystick 436, show a list of widget applications selectable or accessible for use by the user. By way of example and not by way of limitation, widget applications may include a weather widget, calculator widget, calendar widget, wikipedia widget, maps widget, internet browser widget, music playing widget, photo showing widget, sports information widget, a mobileme™ widget, as well as instant messenger widgets (e.g., AIM, yahoo instant messenger, google chat, among others) for accessing and using instant messenger accounts of the user, email widgets for accessing and using email accounts (e.g., yahoo!™, gmail™, or AOL™, or hotmail™, among others) of the user, and social networking widgets for accessing and using social networking accounts of the user. By way of example, social networking accounts may include myspace™, facebook™, twitter™, tagged™, and flickr™, among others.

Mobile device 108 also includes a configuration client 308 that is configured to receive configuration information from management system 102, process the configuration information, and/or update configuration information stored in, for example, memory 306. Configuration client 308 is also generally configured to transmit configuration and other information to management system 102. Configuration client 308 may, by way of example and not by way of limitation, generally be implemented as one or more software programs or applications stored in memory 306.

Management system 102 is configured to present a user interface through a web portal at remote computer 104. By way of example, management system 102 may be configured to present the user interface at remote computer 104 by transmitting, via network link 106, user interface data in the form of, for example, an HTML (Hyper Text Markup Language) document, to a client application (e.g., a web browser) hosted in remote computer 104. When the client application hosted in remote computer 104 consumes the user interface data transmitted by management system 102, the client application, in conjunction with an operating system and other elements of remote computer 104, renders the user interface on a display of the remote computer. A user at remote computer 104 may initiate the process by accessing a website affiliated with the management system 102. The website provides the user interface via the display at remote computer 104 enabling the user to enter, select, update, and/or delete management information and/or configuration information (described below) for configuring the mobile device 108. The management information may be subsequently stored at configuration information database 1 16. Management system 102 is further configured to update configuration information for the mobile device 108 based on the management information. By way of example, in various particular embodiments, configuration information may include contact information, multimedia information, messaging information, call information, widget application information, and /or mobile device settings information.

In particular embodiments, updating configuration information may include reconciling configuration information. Updating and/or reconciling configuration information may include adding new configuration information, modifying configuration information, and/or deleting configuration information. In particular embodiments, management system 102 subsequently stores the updated configuration information in configuration database 103. In various embodiments, storing the updated configuration information in configuration database 103 may involve rewriting all or a portion of configuration information already stored in configuration information database 103.

Management system 102 is further configured to send or transmit configuration information to mobile device 108. In particular embodiments, management system 102 is configured to push the configuration information to the mobile device 108 at predetermined basis, on a period basis, on a continuous basis (e.g., as often as possible), or whenever configuration information is updated at configuration database 103. In particular embodiments, the updated configuration information sent to the mobile device 108 replaces configuration information already stored at the mobile device 108. In some embodiments, the updated configuration information sent to the mobile device 108 only comprises configuration information that differs from configuration information already stored at the mobile device.

In particular embodiments, updating configuration information may include accessing one or more third party servers or systems 112 and third party database 116, pulling selected or particular third party information from the third party servers, and reconciling the pulled third party information with configuration information stored in configuration database 103. In particular embodiments, the third party information may be pulled on a periodic basis, a continuous basis (e.g., whenever the third party servers 112 permit and/or whenever management system 102 permits), on some other predetermined basis, or when management system 102 determines that particular third party information is added, deleted, or updated by third party servers 112.

In particular embodiments, configuration client 308 within mobile device 108 may be configured to transmit configuration information to management system 102. In such embodiments, management system 102 may be configured to receive the configuration information and to update configuration information in configuration information database 103 based on the configuration information received from mobile device 108. By way of example, configuration information transmitted from mobile device 108 to management system 102 may include contact information, messages, and call lists, among other information.

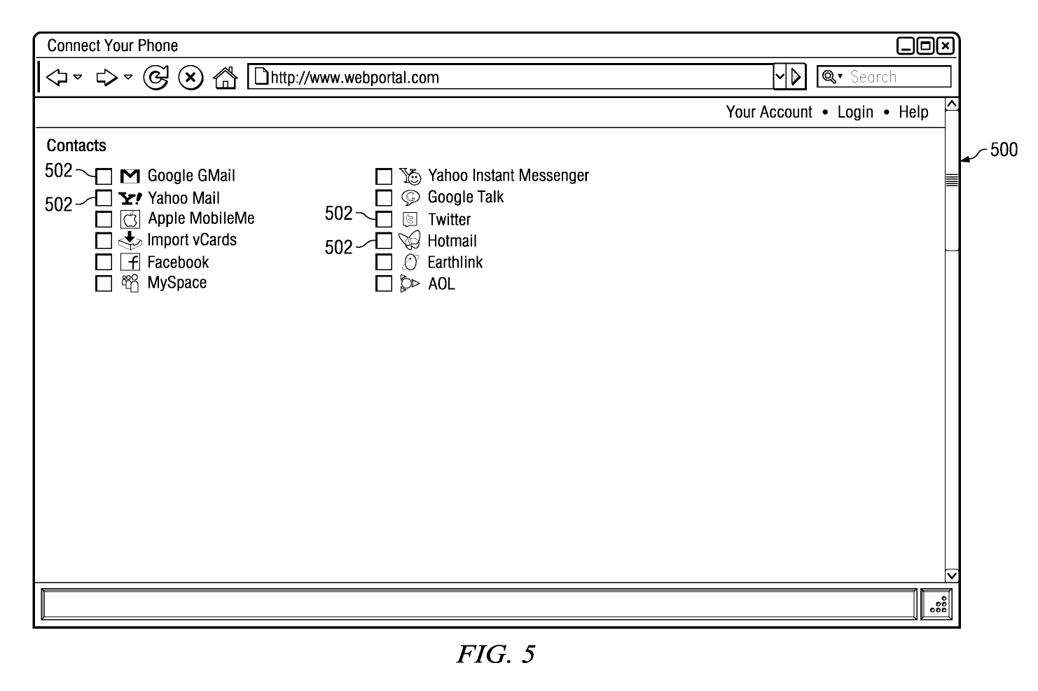

FIG. 5 illustrates an example user interface 500 displayable by management system 102 via remote computer 104 for entering contact management information. In the illustrated embodiment, user interface 500 includes a contacts interface for selecting one or more email, social networking, instant messaging (IM), or other accounts of the user containing contact information. By way of example and not by way of limitation, entering contact management information may include selecting one or more of the various email, social networking, instant messaging, or other accounts by checking the corresponding boxes 502 next to the accounts. In this example, the configuration information includes contact information corresponding to the user's contacts in the respective accounts, and the management system 102 updates the contact information based on the contact management information (e.g., the accounts selected).

The contact information collected by management system 102 may include the actual phone numbers of the contacts, names of the contacts, display names of the contacts, email addresses of the contacts, residential addresses of the contacts, personal webpages of the contacts, statuses of the contacts, photos of the contacts, among other contact information. By way of example, anyone whom the user has emailed may be saved as a contact by the email server and imported as a contact by management system 102. More particularly, the contact's email address, legal name, display name, as well as any other identifying information (hereinafter also referred to as “metadata”) may be imported from third party servers 112 and saved by management system 102 in database 103. As another example, any “friend” of the user in Myspace or Facebook may be imported as a contact by management system 102 along with the friend's legal name, display name, email address, website address, etc. Contacts interface 500 may also be configured to prompt the user with text boxes for entering identifying information used by management system 102 in gaining access to third party servers 112. By way of example, contacts interface 500 may include text boxes for entering the user's name, id, phone number, email address, display name, and/or password. Subsequently, this identifying information may be stored within, by way of example, database 103, such that the user isn't required to enter it again.

In this example, third party servers 112 may correspond to email provider servers, social networking provider servers, instant messaging provider servers, among others, corresponding to the selected accounts, while the third party information may include the contact information received from the corresponding servers. In this example, reconciling configuration information received from third party servers 112 with configuration information in the configuration information database may include comparing the contact information received from third party servers 112 with contact information in the configuration information database and updating and aggregating the contact information in the database based on the comparison. By way of example, new contact information (e.g., new phone numbers, email addresses, residential addresses, statuses, among other contact information) may be added to the database 103, existing contact information may be modified in the database, and/or particular contact information may be deleted from the database. In particular embodiments, management system 102 subsequently pushes the contact information to the mobile device 108 where the user may then access, view, and/or use the contact information via contacts icon 440a.

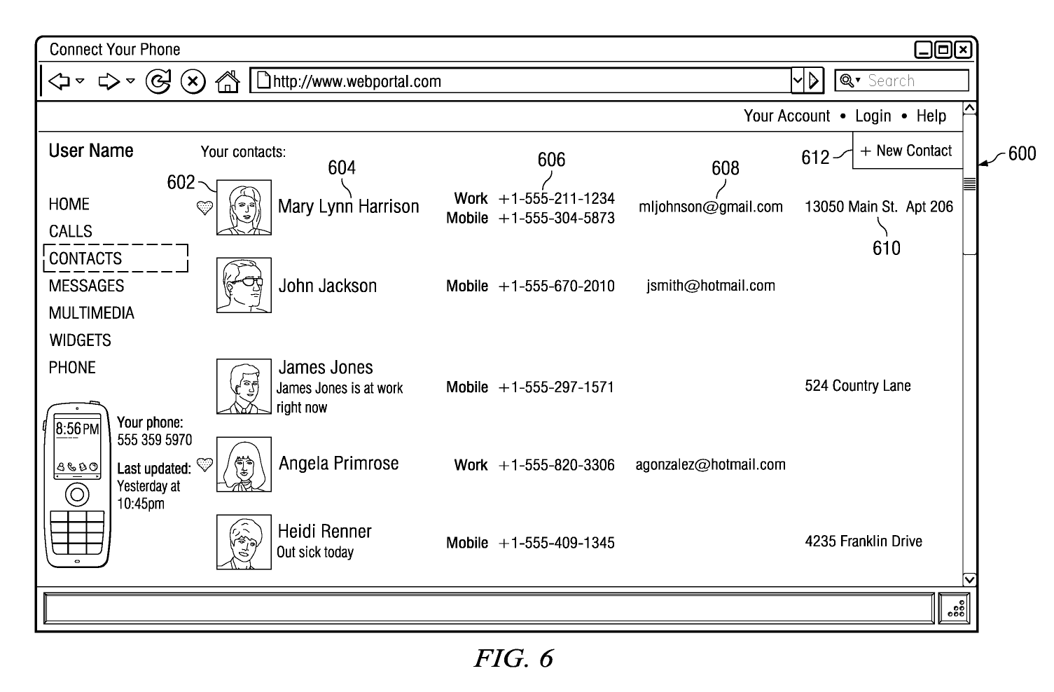

As shown in FIG. 6, the user may also view and manage the contact information updated and aggregated by management system 102 from third party servers 112 via user interface 600 displayable by management system 102 via remote computer 104. User interface 600 may also enable the user to update the aggregated contact information. By way of example, user interface 600 may include picture elements 602 for choosing a picture to be displayed with a particular contact (note that in some embodiments, the picture may be automatically selected from one of a set of aggregated photos described below and displayed by management system 102 via interface 600). Interface 600 may also display the contact's legal name, display name, or both via name fields 604. Additionally, various phone numbers may be displayed in phone number fields 606 while email addresses and residential addresses may be displayed in fields 608 and 610. In particular embodiments, any or all of elements or fields 602, 604, 606, 608, and 610 may be edited via user interface 600. This contact information may also be edited at mobile device 108 whereby the updated data is subsequently pushed to management system 102 where it is then updated at database 103 for subsequent display via interface 600. Furthermore, interface 600 may also include a new contact button or field 612. When field 612 is selected, by way of example, the user may be prompted with an additionally user interface that may, for example, include one or more text boxes for inputting new contact information associated with a new contact.

In particular embodiments, any and all of the aforementioned aggregated contact information is pushed to the mobile device 108 for display and access via the mobile device 108. It should be noted that not all of the aggregated contact information is necessarily transmitted to the mobile device. By way of example, the user may select only selected contact information to be transmitted to the mobile device 108.

In particular embodiments, a user desiring to send a message to a contact via mobile device 108 may be prompted to select the medium by which to send the message. By way of example, the user may access, view, and/or transmit messages and messaging information via messaging icon 440c. Client 308 may then prompt the user as to whether the user would like to send an SMS or other text message to the user via a phone number associated with the contact, an email message via an email address associated with the contact, an IM message via an IM service using the contact's IM handle, or a social networking message via a social networking account associated with the user, for example, or a combination of these message mediums.

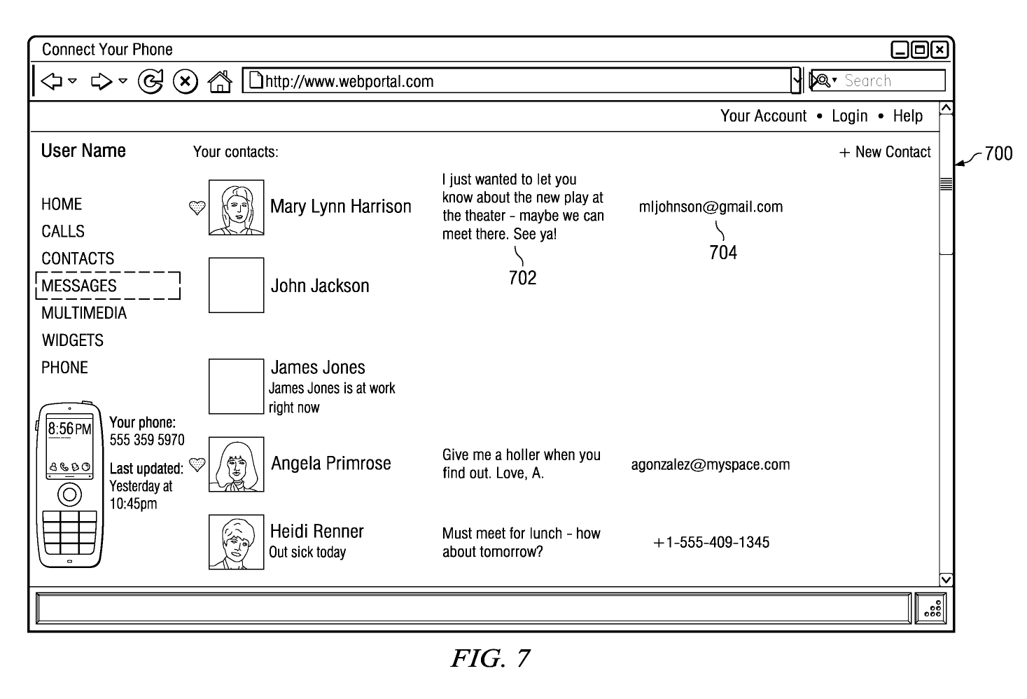

As shown in FIG. 7, the user may also view and manage the messages and other messaging information received by or sent to mobile device 108 via user interface 700 displayable by management system 102 via remote computer 104. By way of example, messages sent by or to specific contacts may be displayed in message fields 702. User interface 700 may also enable the user to view, send, delete, or modify particular messages using the remote computer 104 via message fields 702. Target fields 704 may display the contact and associated contact information corresponding to the messages in message fields 702. By way of example, if a particular target field 704 includes an email address, then the corresponding message in message field 702 was received by or sent to that email address. Similarly, if a particular target field 704 includes a phone number, then the corresponding message in message field 702 was received by or sent to that phone number via an SMS text message.

Furthermore, in particular embodiments, management system 102, via remote computer 104, may also be configured to display a calls interface for viewing or updating a call list (history) made by mobile device 108. By way of example, the user may select calls to delete, voicemails to listen to or forward, among other operations, via the calls interface displayed at remote computer 104. In this example, reconciling configuration information with configuration information in the configuration information database may include comparing a call history received from mobile device 108 with a call history in the configuration information database and updating the call history in the database based on the comparison.

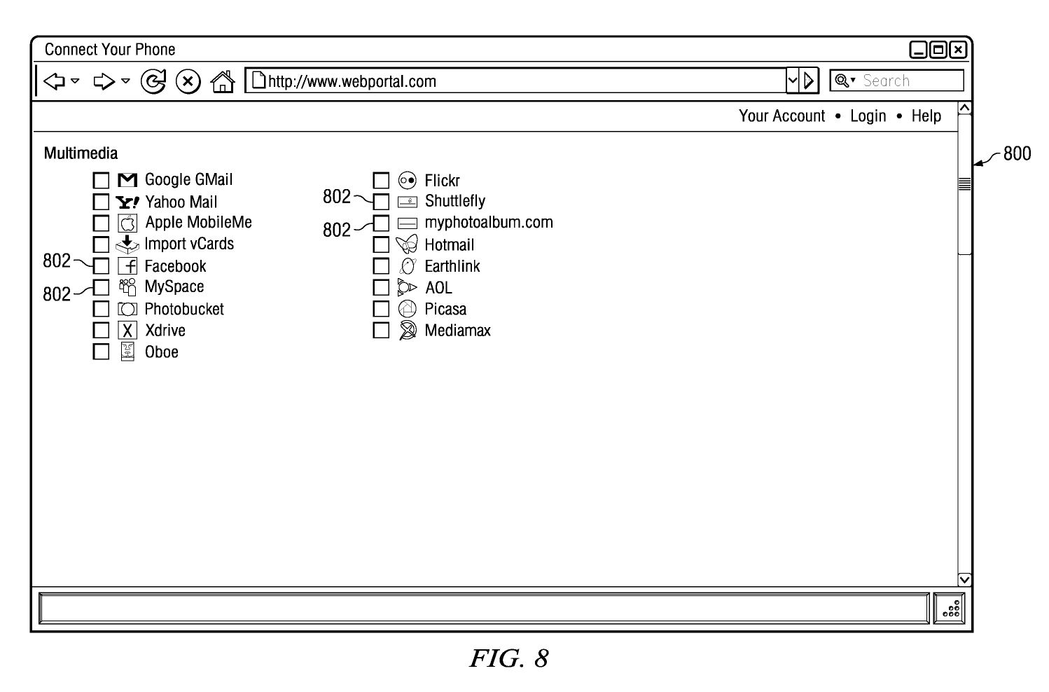

FIG. 8 illustrates an example user interface 800 displayable by management system 102 via remote computer 104 for entering multimedia management information. In the illustrated embodiment, user interface 800 includes a multimedia interface for selecting one or more online photo upload accounts (e.g., flickr, shutterfly, or myphotoalbum.com), online music upload accounts (e.g., xdrive, mediamax, or oboe), or email (which may include photos), social networking (which generally include photos, videos, and/or music), or other accounts of the user. By way of example and not by way of limitation, entering multimedia management information may include the selecting one or more of the various photo, music, email, social networking, or other accounts by checking the corresponding boxes 802 next to the accounts. In this example, the configuration information includes multimedia information such as, by way of example, photos and music corresponding to the user's photo and music containing accounts, and the management system 102 updates the multimedia information based on the multimedia management information (e.g., the accounts selected). Multimedia interface 800 may also be configured to prompt the user with text boxes for entering identifying information used by management system 102 in gaining access to third party servers 112. By way of example, multimedia interface 800 may include text boxes for entering the user's name, id, phone number, email address, display name, and/or password. Subsequently, this identifying information may be stored within, by way of example, database 103, such that the user isn't required to enter it again.

In this example, third party servers 112 may correspond to multimedia provider servers, email provider servers, social networking provider servers, among others, corresponding to the selected accounts, while the third party information may include the multimedia information received from the corresponding servers. In this example, reconciling configuration information received from third party servers 112 with configuration information in the configuration information database may include comparing the multimedia information received from third party servers 112 with multimedia information in the configuration information database and updating and aggregating the multimedia information in the database based on the comparison. By way of example, new multimedia information may be added to the database, existing multimedia information may be modified in the database, and/or particular multimedia information may be deleted from the database. In particular embodiments, management system 102 subsequently pushes the multimedia information to the mobile device 108 where the user may then access, view, and/or use the multimedia information via a music or photos widget, for example.

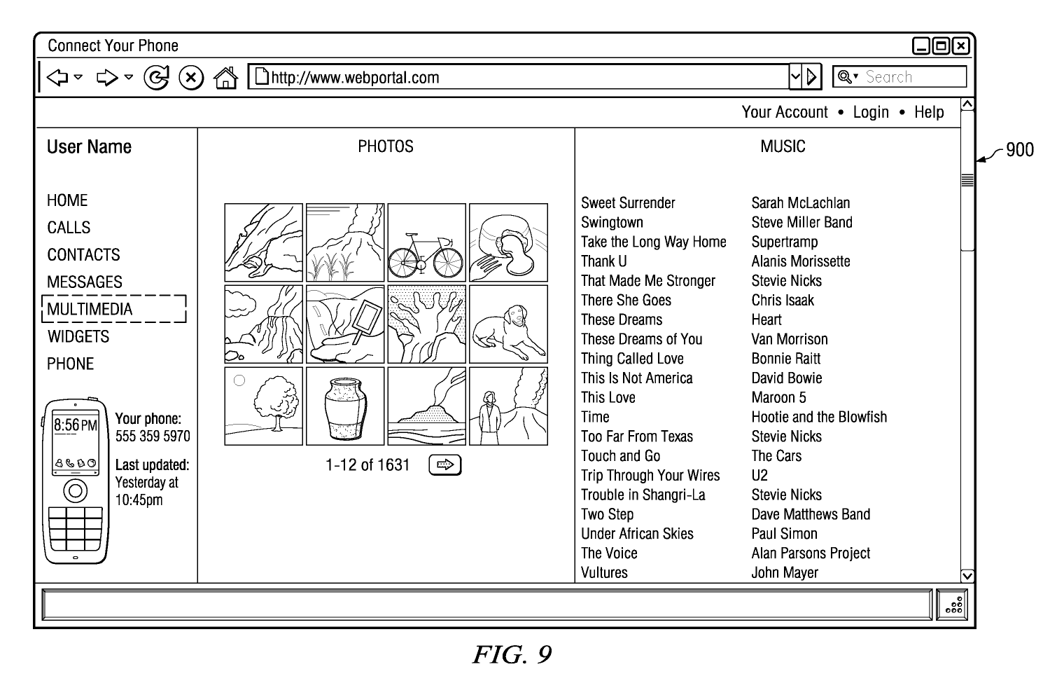

As shown in FIG. 9, the user may also view and manage the multimedia information updated and aggregated by the management system 102 from third party servers 112 via user interface 900 displayable by management system 102 via remote computer 104. User interface 900 may also enable the user to modify the updated multimedia information. By way of example, user interface 900 may enable a user to add captions to selected photos, create albums for selected photos aggregated from one or more accounts, and to rearrange selected photos aggregated from one or more accounts, among other modifications. Similarly, by way of example, user interface 900 may enable a user to create playlists or albums for selected music aggregated from one or more accounts, and to rearrange selected music aggregated from one or more accounts, among other modifications. In particular embodiments, any and all of the aforementioned aggregated multimedia information is pushed to the mobile device 108 for display and access via the mobile device 108. It should be noted that not all of the photos, music, or other aggregated multimedia information is necessarily transmitted to the mobile device. By way of example, the user may select only selected albums or playlists to be transmitted to the mobile device 108. Furthermore, as described above, when a user is prompted to select a photo for display in photo element 602 for a particular contact, the user may be presented with a set of photos associated with that contact (e.g., photos tagged via interface 600 as including that particular contact).

In particular embodiments, management system 102 may also be configured to display, via a web portal, a user interface including a widget interface for selecting one or more widgets to be downloaded to mobile device 108. In this example, the configuration information includes the selected or desired widgets. The widgets interface may enable the user to browse, preview, and install widgets via the web. Selected widgets may be downloaded virtually instantaneously (e.g., in seconds in some embodiments) to mobile device 108 and available for selection using widgets icon 440d. In particular embodiments, widget applications may be implemented via, by way of example, JAVA and/or HTML.

In particular embodiments, management system 102 may also be configured to display, via a web portal, a user interface including a device settings interface for selecting one or more device settings for mobile device 108. In this example, the configuration information includes the selected or desired device settings. The device settings interface may enable the user to browse, preview, and install device settings via the web. Selected device settings may be downloaded virtually instantaneously (e.g., in seconds in some embodiments) to mobile device 108 and immediate viewable or otherwise recognizable. In particular embodiments, device settings include themes, ring tones, and answer tones, ring volumes, speaker volumes, alarm information, time information, among other settings.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

What is claimed is:

1. A system comprising:
one or more management servers comprising one or more processors and one or more tangible computer-readable storage media, the media comprising server instructions operable when executed by the processors to:
present a user interface displayable at a remote host computer, the user interface enabling a user at the remote host computer to input management information for managing a mobile device without requiring the mobile device to be physically connected with the remote host computer;
receive the management information input by the user;
update configuration information for the mobile device based on the management information; and
send the configuration information to the mobile device for configuring the mobile device; and
a configuration information database that stores the configuration information.

2. The system of claim 1, wherein the server instructions are further operable when executed by the processors to:
receive configuration information from the mobile device; and
update the configuration information stored in the configuration information database based on the configuration information received from the mobile device.

3. The system of claim 1, wherein the server instructions operable when executed by the processors to update the configuration information comprise instructions operable when executed by the processors to:
access one or more third party servers;
pull third party information from the third party servers;
aggregate and reconcile the pulled third party information with the configuration information stored in the configuration information database; and
store the reconciled configuration information in the configuration information database.

4. The system of claim 3, wherein the third party information is pulled on a periodic basis, on a continuous basis, on a predetermined basis, or when the one or more management servers determine that particular third party information is added, deleted, or updated at the third party servers.

5. The system of claim 1, wherein all or a portion of the updated configuration information is sent to the mobile device on a periodic basis, on a continuous basis, on a predetermined basis, or when configuration information is updated by the one or more management servers.

6. The system of claim 3, wherein the configuration information comprises contact information for viewing or updating contacts of the user stored in the mobile device, wherein the management information includes contact management information, wherein the contact information is based on the contact management information, and wherein the user interface displayable at the remote host computer comprises a contacts interface that enables the user to enter the contact management information.

7. The system of claim 6, wherein:
the contacts interface enables the user to enter the contact management information by selecting one or more email accounts, social networking accounts, or instant messaging accounts of the user, wherein the third party servers comprise one or more email, social networking, or instant messaging servers corresponding to the one or more email, social networking, or instant messaging accounts, and wherein the third party information comprises contact information including one or more of:
names corresponding to contacts of the user, display names corresponding to contacts of the user, email addresses corresponding to contacts of the user, one phone numbers corresponding to contacts of the user, residential and other addresses corresponding to contacts of the user, photos corresponding to contacts of the user, and statuses corresponding to contacts of the user; and
the server instructions operable when executed by the processors to reconcile the pulled third party information with the configuration information stored in the configuration information database comprise server instructions operable when executed by the processors to compare the contact information with contact information stored in the configuration information database and to update the contact information stored in the configuration information database based on the comparison.

8. The system of claim 3, wherein the configuration information comprises multimedia information for viewing or updating multimedia content stored in the mobile device, wherein the management information includes multimedia management information, wherein the multimedia information is based on the multimedia management information, and wherein the user interface displayable at the remote host computer comprises a multimedia interface that enables the user to enter the multimedia management information.

9. The system of claim 8, wherein:
the multimedia interface enables the user to enter the multimedia management information by selecting one or more multimedia accounts of the user, wherein the third party servers comprise one or more multimedia servers corresponding to the one or more multimedia accounts, and wherein the third party information comprises third party multimedia information; and
the server instructions operable when executed by the processors to reconcile the pulled third party information with the configuration information stored in the configuration information database comprise server instructions operable when executed by the processors to compare the third party multimedia information with multimedia information stored in the configuration information database and to update the multimedia information stored in the configuration information database based on the comparison.

10. The system of claim 9, wherein the multimedia accounts comprise one or more online photo upload or online music upload accounts, and wherein the multimedia information comprises one or more of photos and music.

11. The system of claim 6, wherein the user interface displayable at the remote host computer comprises a messaging interface that enables the user to send messages, read messages, and delete messages associated with contacts from one or more email, social networking, text, or instant messaging accounts.

12. The system of claim 11, wherein the user interface enables the user to select the medium by which to send a message to a particular contact.

13. One or more tangible computer-readable storage media, the media comprising instructions operable when executed by one or more processors to:
present a user interface displayable at a remote host computer, the user interface enabling a user at the remote host computer to input management information for managing a mobile device without requiring the mobile device to be physically connected with the remote host computer;
receive the management information input by the user;
update configuration information in a configuration information database for the mobile device based on the management information; and
send the configuration information to the mobile device for configuring the mobile device.

14. The media of claim 13, wherein the instructions operable when executed by the processors to update the configuration information comprise instructions operable when executed by the processors to:
access one or more third party servers;
pull third party information from the third party servers;
aggregate and reconcile the pulled third party information with the configuration information stored in the configuration information database; and
store the reconciled configuration information in the configuration information database.

15. The media of claim 13, wherein the configuration information comprises contact information for viewing or updating contacts of the user stored in the mobile device, wherein the management information includes contact management information, wherein the contact information is based on the contact management information, and wherein the user interface displayable at the remote host computer comprises a contacts interface that enables the user to enter the contact management information.

16. The media of claim 15, wherein:
the contacts interface enables the user to enter the contact management information by selecting one or more email accounts, social networking accounts, or instant messaging accounts of the user, wherein the third party servers comprise one or more email, social networking, or instant messaging servers corresponding to the one or more email, social networking, or instant messaging accounts, and wherein the third party information comprises contact information including one or more of:
names corresponding to contacts of the user, display names corresponding to contacts of the user, email addresses corresponding to contacts of the user, one phone numbers corresponding to contacts of the user, residential and other addresses corresponding to contacts of the user, photos corresponding to contacts of the user, and statuses corresponding to contacts of the user; and
the instructions operable when executed by the processors to reconcile the pulled third party information with the configuration information stored in the configuration information database comprise server instructions operable when executed by the processors to compare the contact information with contact information stored in the configuration information database and to update the contact information stored in the configuration information database based on the comparison.

17. A method comprising:
presenting a user interface displayable at a remote host computer, the user interface enabling a user at the remote host computer to input management information for managing a mobile device without requiring the mobile device to be physically connected with the remote host computer;
receiving the management information input by the user;
updating configuration information in a configuration information database for the mobile device based on the management information; and
sending the configuration information to the mobile device for configuring the mobile device.

18. The method of claim 17, wherein updating the configuration information comprises:
accessing one or more third party servers;
pulling third party information from the third party servers;
aggregating and reconciling the pulled third party information with the configuration information stored in the configuration information database; and
storing the reconciled configuration information in the configuration information database.

19. The method of claim 17, wherein the configuration information comprises contact information for viewing or updating contacts of the user stored in the mobile device, wherein the management information includes contact management information, wherein the contact information is based on the contact management information, and wherein the user interface displayable at the remote host computer comprises a contacts interface that enables the user to enter the contact management information.

20. The method of claim 19, wherein:
the contacts interface enables the user to enter the contact management information by selecting one or more email accounts, social networking accounts, or instant messaging accounts of the user, wherein the third party servers comprise one or more email, social networking, or instant messaging servers corresponding to the one or more email, social networking, or instant messaging accounts, and wherein the third party information comprises contact information including one or more of:
names corresponding to contacts of the user, display names corresponding to contacts of the user, email addresses corresponding to contacts of the user, one phone numbers corresponding to contacts of the user, residential and other addresses corresponding to contacts of the user, photos corresponding to contacts of the user, and statuses corresponding to contacts of the user; and
reconciling the pulled third party information with the configuration information stored in the configuration information database comprises comparing the contact information with contact information stored in the configuration information database and updating the contact information stored in the configuration information database based on the comparison.
